(19) United States
(12) Patent Application Publication
(10) Pub. No.: US 2014/0300604 A1
(43) Pub. Date: Oct. 9, 2014

(54) VECTOR GRAPHICS AUTHORING TOOL THAT ENABLES DIRECTIONAL INPUT REQUESTS FOR SELECTING REFERENCE POINTS ON A VECTOR PATH OF AN IMAGE BEING AUTHORED

(71) Applicant: Kim Pimmel, San Francisco, CA (US)

(72) Inventor: Kim Pimmel, San Francisco, CA (US)

(73) Assignee: Adobe Systems Incorporated, San Jose, CA (US)

(21) Appl. No.: 11/929,332

(22) Filed: Oct. 30, 2007

(51) Int. Cl. G06T 11/20

(52) U.S. Cl. 345/440

(57) ABSTRACT

A vector graphics authoring tool supports a directional input request for enabling a user to easily and efficiently advance focus from one reference point on a vector path of an image being authored to another reference point. A “directional input request” does not comprise a user directly identifying (e.g., directly clicking on) a reference point that is to receive focus. Instead, directional input requests merely indicate a general direction in which focus is to be advanced from a reference point currently possessing focus. The vector graphics authoring tool determines a next reference point encountered in the indicated direction. In one embodiment, a directional advancement operation is supported by the vector graphics authoring tool in which a user may advance focus from a reference point on a vector path that possesses current focus along the vector path in an indicated direction to another reference point residing on the vector path.

### TECHNICAL FIELD

The following description relates generally to vector graphics authoring tools, and more specifically to a vector graphics authoring tool that enables directional input requests for selecting reference points on a vector path of an image being authored.

### BACKGROUND OF THE INVENTION

Various image authoring applications are available today with which users may interact to create, modify and/or otherwise author graphical images. Such graphical images may be images of any of a wide range of objects, including images of buttons or other user-interaction components to be included in a user interface of a software application, images used in animation, images presented in video games and/or other software applications, etc.

Computers display graphics in either vector or bitmap format. Image authoring applications have been developed for authoring vector and/or bitmap images. In general, vector graphics describe images by using geometrical primitives such as points, lines, curves, and polygons, which are all based upon mathematical equations to represent images in computer graphics. Such geometrical primitives as lines and curves are commonly referred to as vectors in vector graphics, and such vectors may include properties associated therewith such as color and position. For example, an image of a leaf can be described by points through which lines pass, creating an outline of the leaf. The leaf may be filled with a color. The color of the leaf may be determined by the color of the outline and the color of the area enclosed by the outline. In general, when a user edits a vector graphic, the user modifies the properties of the lines and curves that describe its shape. Many vector graphics are represented by quadratic Bézier curves, which generally use three control points to define a curve, two end points and a third control point. Through working with an authoring tool, a user can typically move, rescale, resize, rotate, reshape, and change the fill and/or color of a vector graphic without changing (e.g., degrading) the quality of graphic's appearance. In general, vector graphics are resolution independent. That is, they can be displayed on output devices of varying resolutions without losing any quality.

Bitmap graphics, on the other hand, describe images using colored dots, called pixels, arranged in a grid. For example, an image of a leaf may be described by the specific location and color value of each pixel in the grid, creating an image in much the same manner as a mosaic. When a user edits a bitmap graphic, the user modifies pixels rather than lines and curves. Bitmap graphics are resolution dependent, because the data describing the image is fixed to a grid of a particular size. Editing a bitmap graphic can change the quality of its appearance. In particular, resizing a bitmap graphic can make the edges of the image ragged as pixels are redistributed within the grid. Displaying a bitmap graphic on an output device that has a lower resolution than the image itself also degrades its quality.

Examples of image authoring applications that support authoring of vector graphics include Adobe System Incorporated's FLASH®, FIREWORKS®, FLEX®, and FLEX BUILDER® authoring applications. Such image authoring applications may be implemented as part of a graphical application development environment (GADE) that provides an environment for application developers to create and code complex graphically-driven applications. Such image authoring applications may also include support for authoring of bitmap images. As used herein, a vector graphics authoring application refers generally to any authoring application that supports authoring (e.g., creating, modifying, etc.) vector graphics, including those authoring applications that also support authoring of bitmap graphics.

As discussed further herein, vector graphics authoring applications often present one or more paths that form an image being authored, wherein each path may include one or more segments that are defined by reference points. As discussed further herein, a path may include various types of reference points, such as endpoints, anchor points, corner points, smooth points, etc. Any such point on a path of a vector graphic with which a user may interact (e.g., select) is referred to generally herein as a reference point. A user may interact with segments and/or reference points to modify the image in some desired way. As discussed further hereafter, various editing operations may be supported by a vector graphics authoring application.

In most vector graphics image authoring applications, whenever a user draws a line or shape, the user creates a line called path. A path is made up of one or more straight or curved segments. The beginning and end of each segment are marked by reference points, which may be referred to as endpoint. In general, these points work like pins holding a wire in place. A path can be closed (for example, a circle), or open, with distinct endpoints (for example, a wavy line). A user may change the shape of a path by dragging its reference points, dragging direction points that may be presented by the authoring application at the end of direction lines that appear as a handle at selected reference points, or by dragging the path segment itself. Various other types of authoring operations (e.g., editing operations) may be performed on a vector path by a user interacting with (e.g., selecting) one or more reference points on the path. It will be appreciated that in most instances the reference points are not included as par of the final output graphics image, but are instead presented on the paths by the authoring application to aid a user in authoring (e.g., editing) a vector path. In certain authoring applications, the reference points of a vector path may be presented to a user responsive to the user selecting the path (e.g., by clicking on a portion of the path, etc.) and/or hovering a pointer over the path. In some instances, an authoring application may be configured to show all reference points of all vector paths of an image being authored.

FIG. 1 shows an exemplary system 10 that illustrates a common vector graphics authoring technique of the prior art. As shown, system 10 comprises a processor-based computer 11, such as a personal computer (PC), laptop computer, server computer, workstation computer, etc. In this example, a vector graphics authoring application 12 is executing on such a computer 11 with which a user may interact to author vector-based image(s), such as exemplary image 13 shown. Vector graphics authoring application 12 comprises computer-executable software code stored to a computer-readable medium that is readable by a processor of computer 11 and, when executed by such processor, causes computer 11 to perform the various operations described further herein for such vector graphics authoring application 12. Examples of such a vector graphics authoring application 12 include ADOBE® FIREWORKS®, FLASH®, FLEX®, and FLEX BUILDER®, etc.

Vector graphics authoring application 12 presents a user interface (e.g., to a display of computer 11) with which a user may interact (e.g., via user input devices, such as a keyboard, mouse, etc. of computer 11) for authoring an image. In the illustrated example of FIG. 1, an exemplary image 13 is being authored. Image 13 comprises a path having segments 105, 106, and 107 defined by reference points 101, 102, 103, and 104. In the illustrated example, reference points 101 and 104 may be referred to as endpoints, while reference points 102 and 103 may be referred to as anchor points. Also, in the illustrated example, segments 105 and 106 are straight segments, while segment 107 is an example of a curved path segment.

Vector graphics authoring application 12 enables a user to interact with image 13 to edit such image. For instance, a user may change the shape of the path of one or more of segments 105-107. For example, a user may select one or more of reference points 101-104 and perform an editing operation relative to such selected reference points, such as by dragging a reference point, dragging a segment defined by two reference points, etc. In the illustrated example of FIG. 1, reference point 104 is selected, and a handle 110 is thus presented by the vector graphics authoring application 12. That is, responsive to a user selecting reference point 104, the points 104 and 103 of the segment 107 display direction handles 110, which have direction lines 108 that end in direction points 109. The user can interact with the direction handle 110 in a manner as is well know in such vector graphics authoring applications as ADOBE® FIREWORKS®, FLASH®, and FLEX®, as examples, to modify the segment 107 of image 13. The angle and length of the direction lines 108 determine the shape and size of the curved segment 107. Moving the direction points 109 reshapes the curve. It should be recognized that the handles 110 are presented by the authoring application 12 for aiding a user in editing image 13, and such handles 10 do not appear in the final output of the image 13. Similarly, as mentioned above, the reference points 101-104 are typically presented by the authoring application to aid the user in editing the image 13, and such reference points 101-104 typically do not appear in the final output of the image 13.

In certain vector graphics image authoring applications, paths can have at least two kinds of anchor points: corner points and smooth points. At a corner point, a path abruptly changes direction. At a smooth point, path segments are connected as a continuous curve. A user can draw a path using any combination of corner and smooth points. As an example, FIG. 2 shows an exemplary system 20 of the prior art which illustrates exemplary paths that may be formed in a vector graphics authoring application 12. As with the example of FIG. 1, vector graphics authoring application 12 is executing on computer 11. In the example of FIG. 2, exemplary images 21, 22, and 23 are shown as being authored. Image 21 provides an example of a path that has four corner points 201₁-201₄. Image 22 provides an example of a path containing four smooth points 202₁-202₄. Image 23 provides an example of a path containing a combination of corner and smooth points (e.g., corner points 203₁, 203₃, and 203₄, and smooth point 203₂). Vector graphics authoring application 12 may enable a user to insert a reference point at a desired location on a given path. That is, the path may be subdivided as desired into further segments between the inserted points. And, as discussed further herein, such inserted points on the path may be used for editing the path.

A corner point can connect any two straight or curved segments, while a smooth point connects two curved segments. Corner and smooth points should not be confused with straight and curved segments. A path's outline may be referred to as a stroke. A color or gradient applied to an open or closed path's interior area may be referred to as a fill. Typically, a stroke can have weight (thickness), color, and a dash pattern. After a user creates a path or shape, the user can change various characteristics of it, such as those associated with its stroke and fill.

Thus, vector graphics authoring applications generally support various vector path editing operations, many of which involve a user selecting one or more reference points of the path. One example of a user interacting with a vector graphics authoring application 12 for authoring (e.g., editing) a path of an image is briefly described with FIGS. 3A-3B. FIG. 3A shows an exemplary system 30 of the prior art in which vector graphics authoring application 12 is executing on computer 11, as with the example of FIG. 1. In the example of FIG. 3A, an image being authored comprises a path 31, which comprises reference points 301, 302, and 303 defining segments 304 and 305 of the path. In a first instance 300A (e.g., a first user interface output), a user selects reference point 302, via pointer 306. That is, a user may use pointing device (such as a mouse) to move the pointer (e.g., cursor) 306 to the displayed reference point 302, whereat the user may select the reference point (e.g., by clicking the mouse).

In response to the user selection of reference point 302, a second instance 300B (egg a second user interface output) is presented to the user, which shows reference point 302 indicated as selected (e.g., shown as a solid-filled square, rather than a non-filled square such as those of non-selected reference points 301 and 303). Additionally, a handle 307 may be presented to assist the user in performing editing operations relative to the selected reference point 302. Thus, when a user selects a point (e.g., point 302) that connects curved segments 304 and 305 (or selects the segment itself), the vector graphics authoring application 12 may present an interface such that points of the connecting segments display direction handies, which have direction lines that end in direction points. The user may interact with the direction lines and/or direction points to edit path 31. For instance, in this example, the angle and length of the direction lines determine the shape and size of the curved segments. Moving the direction points reshapes the curves. Again, direction lines do not appear in the final output of the image.

In certain vector graphics authoring applications 12, two direction lines are presented when a user selects a smooth point, such as smooth point 302 of FIG. 3A, wherein the two direction lines move together as a single, straight unit. In certain vector graphics authoring applications 12, when a user moves a direction line on a smooth point 302, the curved segments 304, 305 on both sides of the point 302 are adjusted simultaneously, maintaining a continuous curve at that reference point 302. On the other hand, a corner point can have one, two, or no direction lines, depending on whether it joins one, two, or no curved segments, respectively. Corner point direction lines maintain the corner by using different angles. Thus, in certain vector graphics authoring applications 12, when a user moves a direction line on a corner point, only the curve on the same side of the point as that direction line is adjusted.

In certain vector graphics authoring applications 12, direction lines are generally tangent to (perpendicular to the radius of) the curve at the selected reference point. The angle of each direction line determines the slope of the curve, and the length of each direction line determines the height, or depth, of the curve. For example, FIG. 3B shows exemplary modifications to path 31 (of FIG. 3A) through a user manipulating the direction lines and/or direction points of handle 307, thus forming paths 31A, 31B, and 31C.

In many instances, a user may desire to select various reference points on a given path of interest. For instance, the exemplar editing operations described above and/or other editing operations may be performed once reference points on a given path of interest are selected.

In many cases, difficulty arises in a user selecting the desired reference points of a path. That is, a user may experience difficulty and inefficiency in selecting the desired reference points of a path using a traditional user interface of a vector graphics authoring application 12. Particularly when the graphics image being authored is complex and contains many path segments and/or reference points that overlap and/or are arranged in close proximity to each other, the user may have difficulty distinguishing which reference points are contained on a given path. Additionally, a user may have difficulty accurately placing a pointer over a given reference point desired to be selected with sufficient precision that might be required for selecting such given reference point instead of one or more other reference points that are arranged in close proximity to the given reference point.

FIGS. 4A-4B show an exemplary system 40 of the prior art in which vector graphics authoring application 12 is executing on computer 11, as with the example of FIG. 1. In the example of FIG. 4A, an image being authored comprises paths 41, 42, 43, and 44 that are arranged in close proximity to each other. Path 41 includes reference points 401₁, 401₂, and 401₃; path 42 includes reference points 402₁, 402₂, and 402₃; path 43 includes reference points 403₁, 403₂, and 403₃; and path 44 includes reference points 404₁, 404₂, and 404₃. A user may have difficulty distinguishing which reference point belongs to which path, and/or a user may have difficulty selecting one or more reference points that are desired to be selected due, for instance, to the close proximity at which the paths are arranged to each other. Suppose, for instance, that a user desires to select reference points 402₁-402₃ of path 42, which are shown as selected (e.g., indicated by solid-filled squares) in the example of FIG. 4A. The user may move pointer 405 over each of the reference points 402₁-402₃ and click a pointing device (e.g., mouse) on each reference point 402₁-402₃ to select such reference points.

In certain vector graphics authoring applications 12, a user can select multiple reference points, such as points 402₁-402₃ by clicking (with a mouse) on one or more of the reference points desired to be selected while holding down some key on a keyboard. For instance, the user may hold down “shift” and click the first and last reference point in a range of reference points along a path, wherein all reference points in such range will be selected. For example, the user may hold down “shift” and click reference point 402₁ and then reference point 402₃, and in response all reference points in the range 402₁-402₃ are selected. Alternatively, the user may hold down “control” and click each reference point desired to be selected on a path. For instance, the user may hold down “control” and click reference point 402₁ and then reference point 402₃, wherein such reference points 402₁ and 402₃are selected without selecting reference point 402₃. Of course, the user may hold down “control” and individually click on each of reference points 402₁, 402₃, and 402₃, thereby selecting all of reference points 402₁-402₃.

FIG. 4B shows another exemplary technique that a user may employ in certain vector graphics authoring applications 12 for selecting reference points on vector path(s). In the example of FIG. 4B, a user may click and drag pointer 405 to form a selection box 410, wherein all reference points contained within such selection box 410 are selected. For instance, a user may click pointer 405 at a position 411 of the display at which the user desires an upper lefthand corner of selection box 410, and the user may drag pointer 405 (while holding the clicked button of the mouse) to the position desired for a lower righthand corner of selection box 410, thus forming box 410 as shown in FIG. 4B. In the example of FIG. 4B, selection box 410 encompasses reference points 401₁, 401₂, 402₁, 402₂, 403₁, 403₂, 404₁, and 404₂, and thus all of these reference points are shown as selected.

As mentioned above, in many instances, such as when the graphics image being authored is complex and contains many path segments and/or reference points that overlap and/or are arranged in close proximity to each other, the user may have difficulty distinguishing which reference points are contained on a given path. For instance, the user may have difficulty distinguishing reference points 402₁-402₃ for selection in the example of FIG. 4A, considering how closely arranged the paths 41-44 and their respective reference points are relative to each other. Additionally, a user may have difficulty accurately placing pointer 405 over the given reference points 402₁-402₃ desired to be selected with sufficient precision that might be required for selecting such reference points instead of one or more of the other reference points that are arranged in close proximity thereto. Further still, while a selection box 410 (as in FIG. 4B) may enable a user to quickly select a number of reference points, it may be difficult/impossible to form a selection box 410 that contains only the reference points desired to be selected. For instance, a user would have difficulty creating a selection box 410 that encompasses reference points 402₁-402₃ without also encompassing other reference points that may not be desired for selection.

Thus, a desire exists for a vector graphics authoring application that supports an improved user interaction therewith for more easily and/or efficiently selecting reference points on a vector path.

### BRIEF SUMMARY OF THE INVENTION

The present invention is directed generally to systems and methods for selecting reference points on a vector path of a vector graphic being authored in a vector graphics authoring tool As described further herein, embodiments of the present invention provide a vector graphics authoring tool that support a directional input request for enabling a user to easily and efficiently advance focus from one reference point on a vector path of an image being authored to another reference point. As used herein, a “directional input request” does not comprise a user directly identifying (e.g., directly clicking on) a reference point that is to receive focus. Instead, directional input requests merely indicate a general direction in which focus is to be advanced from a reference point currently possessing focus, and the vector graphics authoring tool is operable to determine a next reference point encountered in the indicated direction. The directional input request may be input by a user in any of a number of different ways, including as examples pressing of an arrow key on a keyboard that specifies the general direction, dragging a pointing device (e.g., mouse) in the general direction, moving a finger on a touchpad in the general direction, etc. As described further herein, by supporting such directional input requests for advancing focus from one reference point to another reference point, a vector graphics authoring tool according to embodiments of the present invention provides an alternative selection process to the traditional selection techniques of the prior art (described above), which may greatly aid a user in easily and efficiently selecting desired reference points in a vector image, particularly when the image contains many reference points that are arranged in close proximity to each other and/or contains complex (e.g., overlapping) vector paths.

As described further herein, in certain embodiments, a directional advancement operation is supported by the vector graphics authoring tool in which a user may advance focus from a reference point on a vector path that possesses current focus along the vector path in an indicated direction to another reference point residing on the vector path. That is, in certain embodiments, a directional advancement operation is supported that enables directional advancement of focus along a given vector path, whereby focus can be directionally advanced from one reference point to other reference point(s) that all reside on a common vector path.

In certain embodiments, another directional advancement operation is supported by the vector graphics authoring tool in which a user may advance focus from a reference point on a vector path that possesses current focus in an indicated direction to another reference point that may reside on a different vector path. That is, in certain embodiments, a directional advancement operation is supported that enables directional advancement of focus from a reference point residing on a first vector path to a reference point residing on a different vector path. In certain embodiments, a specific command, such as inputting a hot-key sequence (e.g., pressing the key “J” on a keyboard) may trigger jumping from one vector path to another. For instance, directional advancement may proceed along a given vector path until a specific command (e.g., the “J” key being pressed) is received for the directional advancement operation, which may cause focus to jump in the indicated direction to a reference point on a different vector path. In other embodiments, the vector graphics authoring tool may be configured to support a directional advancement operation in which advancement is made from a reference point possessing current focus to a nearest adjacent reference point in the indicated direction, irrespective of whether the adjacent reference point resides on the same vector path as the reference point from which focus is advancing.

In certain embodiments, the vector graphics authoring tool supports not only directionally advancing from a reference point to a next reference point one at a time, but may support an advancement operation in which a user may advance focus by a plurality of reference points at a time. For instance, in response to one directional input request, the vector graphics authoring tool may advance focus by two or more reference points in the indicated direction.

Also, as described further herein, in certain embodiments, the vector graphics authoring tool may support a directional advancement operation in which the authoring tool automatically selects each reference point which receives focus. That is, a user may directionally advance focus from one reference point to a next reference point, thereby resulting in a range of a plurality of reference points that have received focus, wherein the vector graphics authoring tool may automatically select all of the reference points in the range. As one example, the “shift” key on a keyboard may be used to specify that such automatic selection of a range of reference points is desired. The range may be expanded by performing directional advancement in one direction and the range may be collapsed by returning in the opposite direction. All reference points contained in the defined range may be automatically selected by the authoring tool.

Further, in certain embodiments, the vector graphics authoring tool may also support a directional advancement operation that enables individual selection of a reference point that gains focus. That is, a user may directionally advance focus from one reference point to a next reference point, and as each individual reference point gains focus, the user may determine whether to select such reference point. As one example, the “control” key on a keyboard may be used to specify that such individual reference point selection is desired. Once focus is advanced to a reference point desired to be selected, the user may input a selection (e g., by pressing the “enter” key on a keyboard, which may toggle between selection and de-selection of a reference point having focus). As a result of this operation, a user may select a plurality of non-adjacent reference points, rather than selecting a continuous range of adjacent reference points using the above-mentioned exemplary automatic selection operation.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary system that illustrates a common vector graphics authoring technique of the prior art;

FIG. 2 shows an exemplary system which illustrates exemplary paths that may be formed in a vector graphics authoring application of the prior art;

FIGS. 3A-3B show one example of a user interacting with a vector graphics authoring application of the prior art for authoring (e.g., editing) a path of an image, which involves selecting a reference point on the path.

FIGS. 4A-4B show examples of a user interacting with a vector graphics authoring application of the prior art for selecting reference points on vector path(s);

FIGS. 5A-5C show an exemplary system illustrating aspects of one embodiment of the present invention, wherein an exemplary directional advancement operation that enables automatic selection of reference points is supported by a vector graphics authoring tool;

FIGS. 6A-6C show an exemplary system illustrating another embodiment of the present invention, wherein an exemplary directional advancement operation that enables individual selection of reference points is supported by a vector graphics authoring tool;

FIGS. 7A-7B show one exemplary embodiment of the present invention in which a user can directionally advance focus along a vector path by two or more reference points at a time;

FIGS. 8A-8B show an exemplary directional-advancement operation for advancing from a reference point on one vector path to a reference point on another vector path according to one embodiment of the present invention;

FIGS. 9A-9B show an exemplary directional-advancement operation for simultaneously advancing focus along multiple vector paths according to one embodiment of the present invention;

FIG. 10 shows an exemplary operational flow diagram of a vector graphics authoring tool according to one embodiment of the present invention; and

FIG. 11 shows an exemplary system on which a vector graphics authoring tool may be implemented according to one embodiment of the present invention.

### DETAILED DESCRIPTION OF THE INVENTION

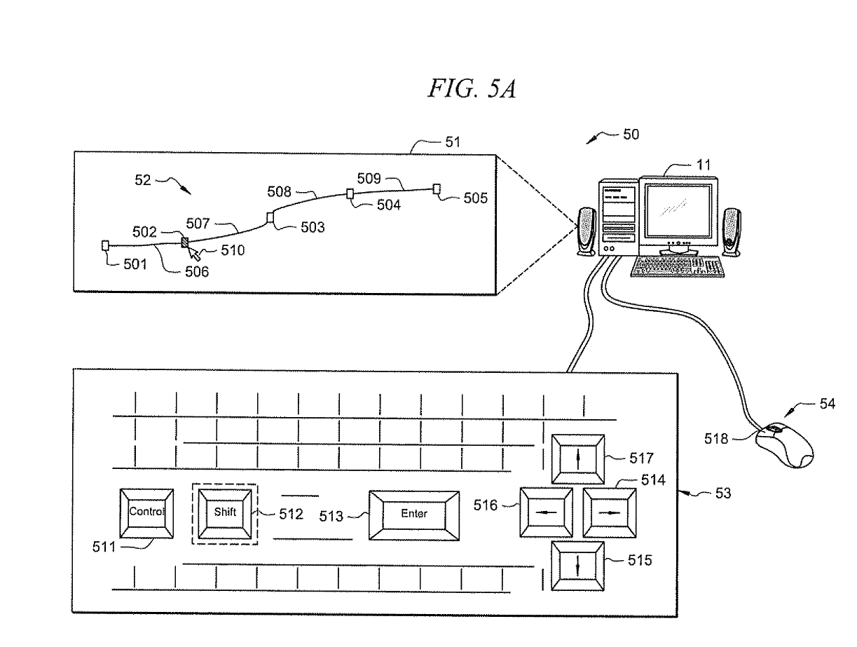

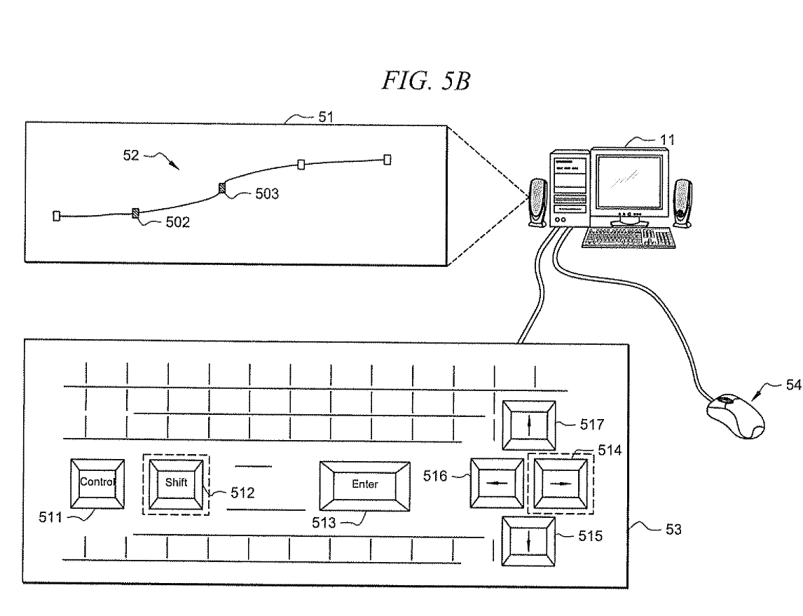

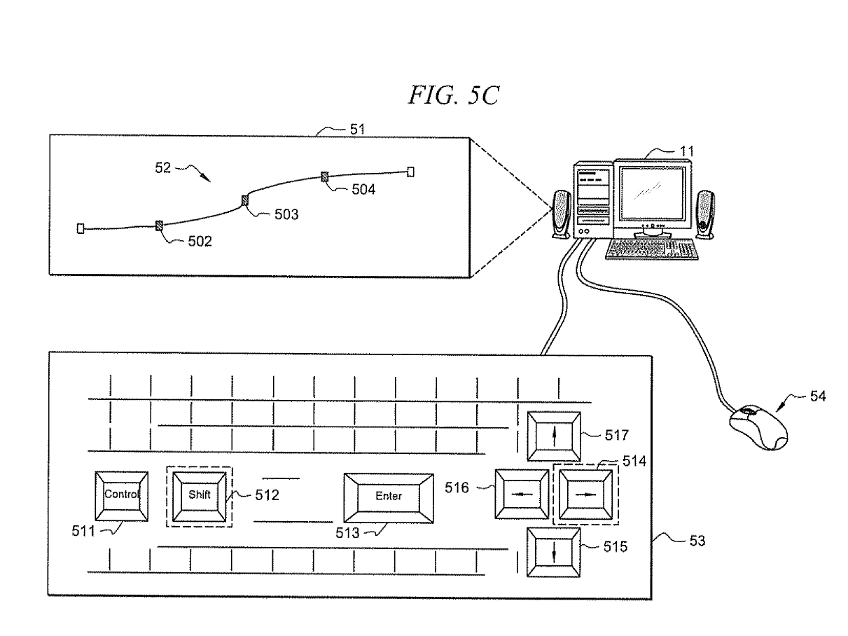

Turning to FIGS. 5A-5C, an exemplary system 50 illustrating aspects of one embodiment of the present invention is shown. As shown, system 50 comprises a processor-based computer 11 such as a personal computer (PC), laptop computer, server computer, workstation computer, etc. In this example, a vector graphics authoring application 51 is executing on such a computer 11. While vector graphics authoring application 51 is shown as executing on computer 11 for ease of illustration in FIGS. 5A-5C, it should be recognized that such application may be residing and/or executing either locally on computer 11 or on a remote computer to which computer 11 is communicatively coupled via a communication network, such as a local area network (LAN), the Internet or other wide area network (WAN), etc.

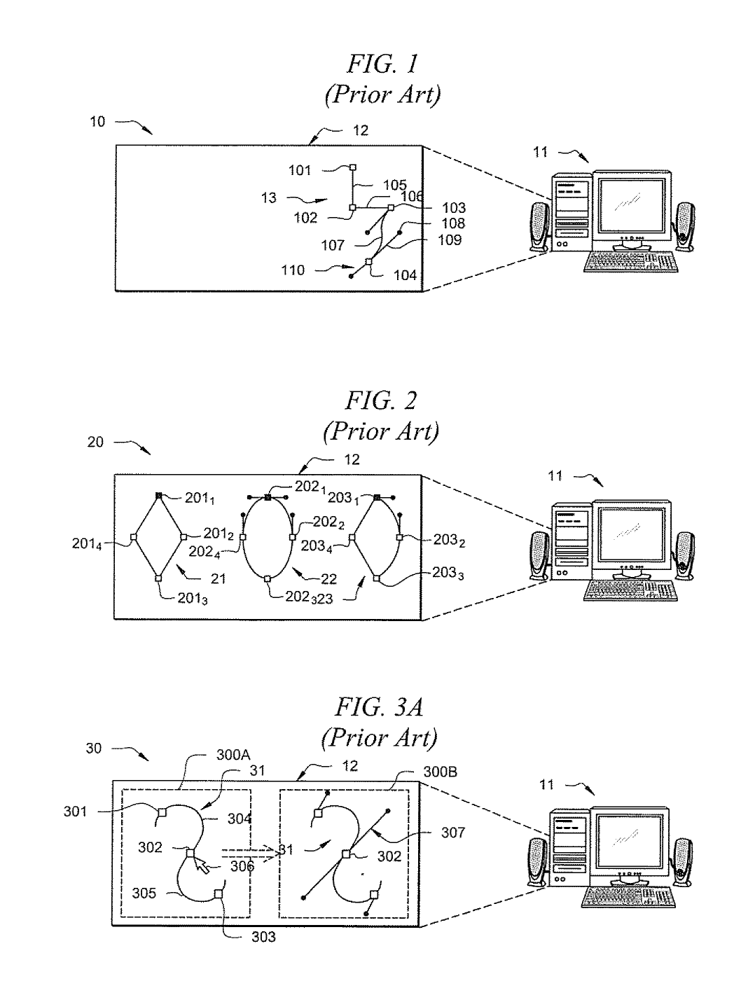

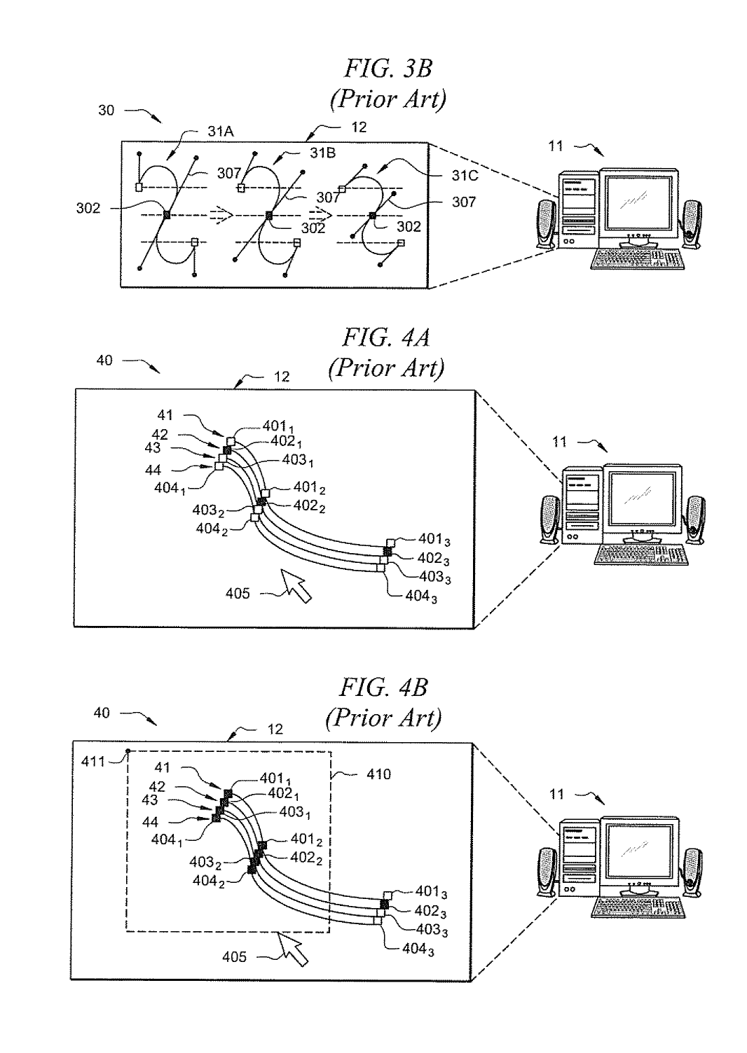

As with the exemplary vector graphics authoring application 12 described above with FIGS. 1-4B, vector graphics authoring application 51 comprises computer-executable software code stored to a computer-readable medium that is readable by a processor of computer 11 and, when executed by such processor, causes computer 11 to perform the various operations described further herein for such vector graphics authoring application 51. Examples of such a vector graphics authoring application 51 include ADOBE® FIREWORKS®, FLASH®, FLEX®, FLEX BUILDER®, etc.

As with the traditional vector graphics authoring application 12 described above, vector graphics authoring application 51 (which may also be referred to herein as an “authoring tool”) enables authoring of vector graphics, such as creating, modifying, and/or otherwise authoring vector graphics. That is, a user can interact with vector graphics authoring application 51 to author vector graphics. Accordingly, vector graphics authoring application 51 presents a user interface (e.g., to a display of computer 11) with which a user may interact (e.g., via user input devices, such as a keyboard 53, mouse 54, etc. of computer 11) for authoring an image. In the illustrated example of FIG. 5A, an exemplary vector graphic image 52 is being authored. Image 52 comprises a path having segments 506, 507, 508, and 509 defined by reference points 501, 502, 503, 504, and 505.

According to this exemplary embodiment, vector graphics authoring application 51 enables a user to select any reference point on the path, and directionally advance to succeeding reference points along the path in order to select reference points that are of interest to the user. As an example, a user may interact with keyboard 53, which may include such buttons as control 511, shift 512, enter 513, as well as directional keys 514-517 (including right key 514, down key 515 left key 516, and up key 517), and/or mouse 54 for selecting a point on path 52 and directionally advancing from one point to the next along such path 52, whereby the user can easily select reference points that are of interest. That is, according to certain embodiments, a user can easily advance from one point to the next on a given vector path that is of interest with assurance that the points are on a common vector path.

Thus, vector graphics authoring tool 51 may receive a directional input request from a user, thereby enabling the user to easily and efficiently advance focus from one reference point on vector path 52 being authored to another reference point. Such, a “directional input request” does not comprise a user directly identifying (e.g., directly clicking on) a reference point that is to receive focus. Instead, directional input requests merely indicate a general direction in which focus is to be advanced from a reference point currently possessing focus, and the vector graphics authoring tool 51 is operable to determine a next reference point encountered in the indicated direction. The directional input request may be input by a user in any of a number of different ways, including as examples pressing of a directional key (e.g., an arrow key) on a keyboard that specifies the general direction (such as arrow keys 514-517 on keyboard 53), dragging a pointing device (e.g., mouse 54) in the general direction, moving a finger on a touchpad input device in the general direction, etc.

For instance, in the example of FIG. 5A, a user moves pointer 510 (via interaction with mouse 54) to be positioned over a first reference point on path 52 that is desired to be selected by the user. Thus, the user may directly identify such first reference point via traditional techniques of pointing and clicking on the first reference point. In the illustrated example, the user desires to select reference point 502. Thus, once pointer 510 is positioned over reference point 502, the user clicks button 518 of mouse 54 to select such reference point 502. According to this exemplary embodiment, the user holds down a hot-key on keyboard 53 while activating button 518 of mouse 54, thereby triggering a directional-advancement procedure of the authoring tool 51. That is, the user may hold down a hot-key on keyboard 53 to indicate a mode of operation is desired for authoring tool 51 in which directional input requests are to be received for directionally advancing focus to another reference point. In the illustrated example, the user holds down shift button 512 while clicking button 518 on reference point 502.

Then, as show in FIG. 5B, the user may use directional keys 514-517 while continuing to hold down shift key 512 for inputting directional input to authoring tool 51 for directionally advancing from reference point 502 to a next reference point on path 52. In the illustrated example, the user presses right key 514 while continuing to hold down shift key 512, thus directionally advancing to the right along path 52 from reference point 502, thereby advancing to reference point 503. Thus, focus is advanced to the adjacent reference point 503 to the right of reference point 502. In this exemplary embodiment, such reference point 503 is automatically selected in addition to the originally-selected reference point 502.

Thereafter, as shown in FIG. 5C, the user may again use directional keys 514-517 while continuing to hold down shift key 512 for further directionally advancing focus to a next reference point on path 52. In the illustrated example, the user again presses right key 514 while continuing to hold down shift key 512, thus directionally advancing to the right along path 52 from reference point 503, thereby advancing to reference point 504. Thus, focus is advanced to the adjacent reference point 504 to the right of reference point 503 that had focus. In this exemplary embodiment, such reference point 504 is automatically selected in addition to the reference points 502 and 503. Of course, instead of advancing to the right from reference point 503 in the manner illustrated, the user may choose to advance to the left (by pressing left key 516), which would de-select reference point 503 and return focus to the originally selected reference point 502.

Thus, as shown in the above example of FIGS. 5A-5C, in certain embodiments, the vector graphics authoring tool 51 may support a directional advancement operation in which the authoring tool 51 automatically selects each reference point which receives focus. That is, a user may directionally advance focus from one reference point to a next reference point, thereby resulting in a range of a plurality of reference points that have received focus (e.g., reference points 502-504 in FIG. 5C), wherein the vector graphics authoring tool 51 may automatically select all of the reference points in the range. The range may be expanded by performing directional advancement in one direction and the range may be collapsed by returning in the opposite direction. All reference points contained in the defined range may be automatically selected by the authoring tool.

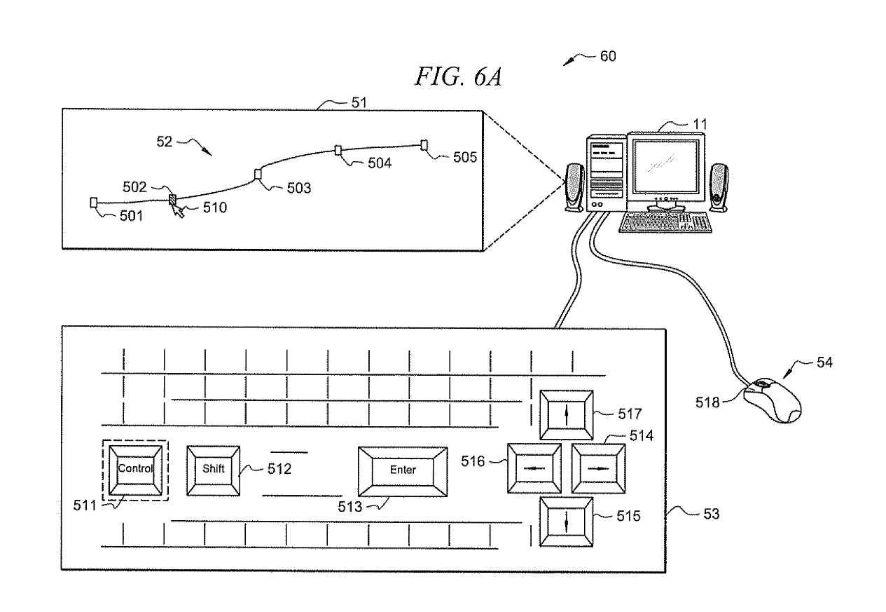

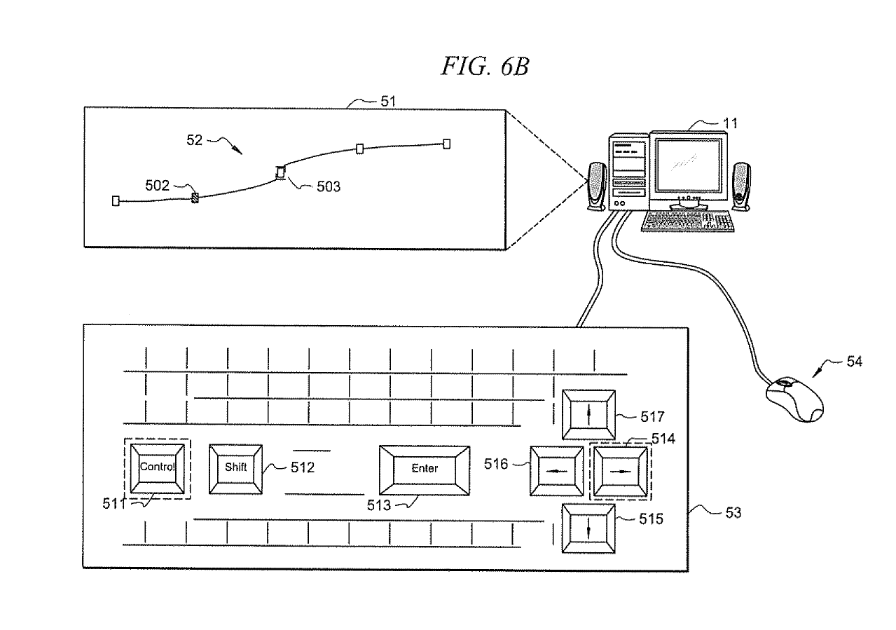

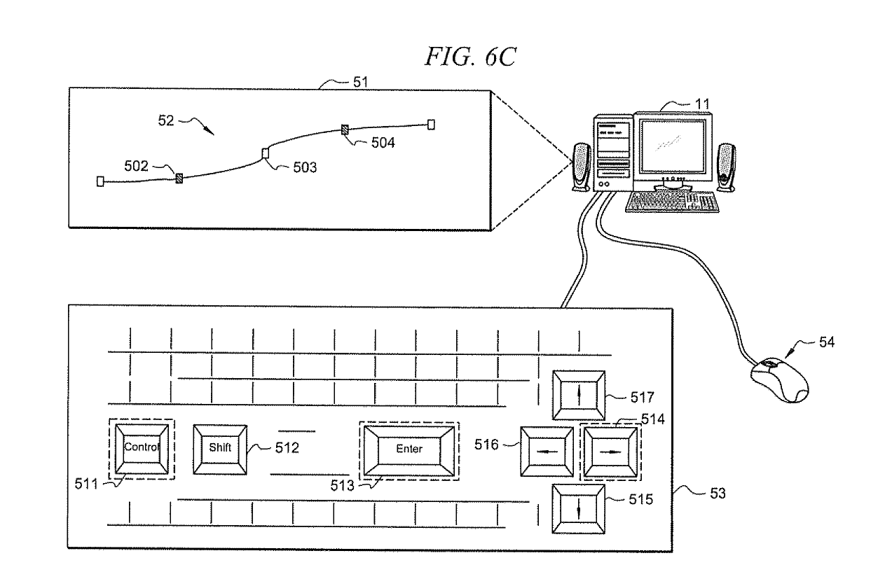

While he exemplary technique of FIGS. 5A-5C provide for automatic selection of each reference point to which a user directionally advances focus along path 52, certain embodiments enable selective selection of points to which a user so advances. For instance, turning to FIGS. 6A-6C, an exemplary system 60 illustrating another exemplary embodiment of the present invention is shown. As shown, system 60 comprises a processor-based computer 11 such as a personal computer (PC), laptop computer, server computer, workstation computer, etc. As in the example of FIGS. 5A-5C, vector graphics authoring application 51 is executing on such a computer 11. Again, vector graphics authoring application 51 presents a user interface (e.g., to a display of computer 11) with which a user may interact (e.g., via user input devices, such as a keyboard 53, mouse 54, etc. of computer 11) for authoring an image. In the illustrated example of FIG. 6A, an exemplary vector graphics image 52 is again being authored, which again comprises a path having reference points 501, 502, 503, 504, and 505.

According to this exemplary embodiment, vector graphics authoring application 51 enables a user to select any reference point on the path, and directionally advance focus to succeeding reference points along the path, wherein a user can choose to select individual ones of the reference points to which focus is advanced. That is, in this example, each reference point to which focus is advanced is not automatically selected, as in the example of FIGS. 5A-5C discussed above. For instance, in the example of FIG. 6A, a user moves pointer 510 (via interaction with mouse 54) to be positioned over a first reference point on path 52 that is desired to be selected by the user. In the illustrated example, the user desires to select reference point 502. Thus, once pointer 510 is positioned over reference point 502, the user clicks button 518 of mouse 54 to select such reference point 502. Thus, the first reference point 502 may be directly identified by the user using traditional point-and-click techniques. According to this exemplary embodiment, the user holds down a hot-key on keyboard 53 while activating button 518 of mouse 54, thereby triggering a directional-advancement procedure of the authoring tool 51.

In the illustrated example, the user holds down control button 511 while clicking button 518 on reference point 502. Then, as show in FIG. 6B, the user may use directional keys 514-517 while continuing to hold down control key 511 for directionally advancing from reference point 502 to a next reference point on path 52. In the illustrated example, the user presses right key 514 while continuing to hold down control key 511, thus directionally advancing to the right along path 52 from reference point 502, thereby advancing to reference point 503. Thus, focus is advanced to the adjacent reference point 503 to the right of reference point 502. In this exemplary embodiment, such reference point 503 is not automatically selected in addition to the originally selected reference point 502. If the user desires to select such reference point 503, the user may press a further button, such as by pressing enter key 513. In the illustrated example, the user does not so select reference point 503.

Thereafter, as shown in FIG. 6C, the user may again use directional keys 514-517 while continuing to hold down control key 511 for further directionally advancing focus to a next reference point on path 52. In the illustrated example, the user again presses right key 514 while continuing to hold down control key 511, thus directionally advancing to the right along path 52 from reference point 503, thereby advancing to reference point 504. Thus, focus is advanced to the adjacent reference point 504 to the right of reference point 503 that previously had focus. In this exemplary embodiment, such reference point 504 is not automatically selected, but instead a user may choose to select such reference point 504 by, for example, pressing enter key 513, as shown in FIG. 6C. Thus, this exemplary technique enables a user to directionally advance focus along a vector path from one reference point to another reference point on the path, and the user can choose individual ones of the reference points for selection. As a result, the user may select non-adjacent reference points on a path, as shown in FIG. 6C (e.g., non-adjacent points 502 and 504 are selected). That is, a non-contiguous range of reference points along a vector path may be selected using the above technique of one embodiment of the present invention.

Accordingly, in certain embodiments, the vector graphics authoring tool 51 may also support a directional advancement operation that enables individual selection of a reference point that gains focus. That is, a user may directionally advance focus from one reference point to a next reference point, and as each individual reference point gains focus, the user may determine whether to select such reference point. Once focus is advanced to a reference point desired to be selected, the user may input a selection (e.g., by pressing the “enter” key on a keyboard, which may toggle between selection and de-selection of a reference point having focus). As a result of this operation, a user may select a plurality of non-adjacent reference points, rather than selecting a continuous range of adjacent reference points using the above-mentioned exemplary automatic selection operation of FIGS. 5A-5C.

Thus, according to the above examples, vector graphics authoring tool 51 may support a first directional-advancement procedure which provides a continuous-range selection of reference points, as in the example of FIGS. 5A-5C. That is, vector graphics authoring tool 51 may support a first user input sequence (such as depressing shift key 512 while directionally advancing focus along the vector path by using, for example, directional keys 514-517), wherein each reference point contained in a range of reference points from the originally-selected reference point 502 to the current reference point having focus is automatically selected. For instance, in the example of FIGS. 5A-5C, the user first selects reference point 502 and then uses the directional advancement to advance focus along path 52 to the right to reference point 504, whereby all of reference points 502, 503, and 504 contained in the directional range from point 502 to point 504 are automatically selected, as shown in FIG. 5C.

Additionally or alternatively, according to the above examples, vector graphics authoring tool 51 may support a second directional-advancement procedure which provides an individual selection of reference points (which may result in selection of non-adjacent reference points), as in the example of FIGS. 6A-6C. That is, vector graphics authoring tool 51 may support a second user input sequence (such as depressing control key 511 while directionally advancing focus along the vector path by using, for example, directional keys 514-517), wherein each reference point contained in a range of reference points from the originally-selected reference point 502 to the current reference point having focus is not automatically selected, but may instead be individually selected by further user input such as by activating enter key 513. For instance, in the example of FIGS. 6A-6C, the user first selects reference point 502 and then uses the directional advancement to advance focus along path 52 to the right to reference point 504, and then individually selects (e.g., by pressing enter key 513) reference point 504 to result in reference points 502 and 504 being selected without selection of the intermediate reference point 503, as shown in FIG. 6C.

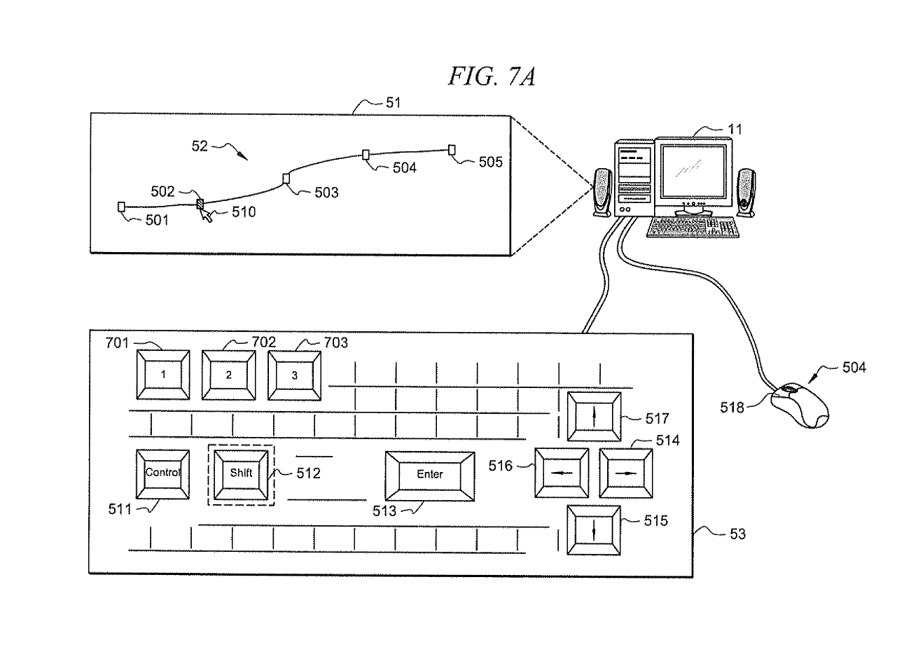

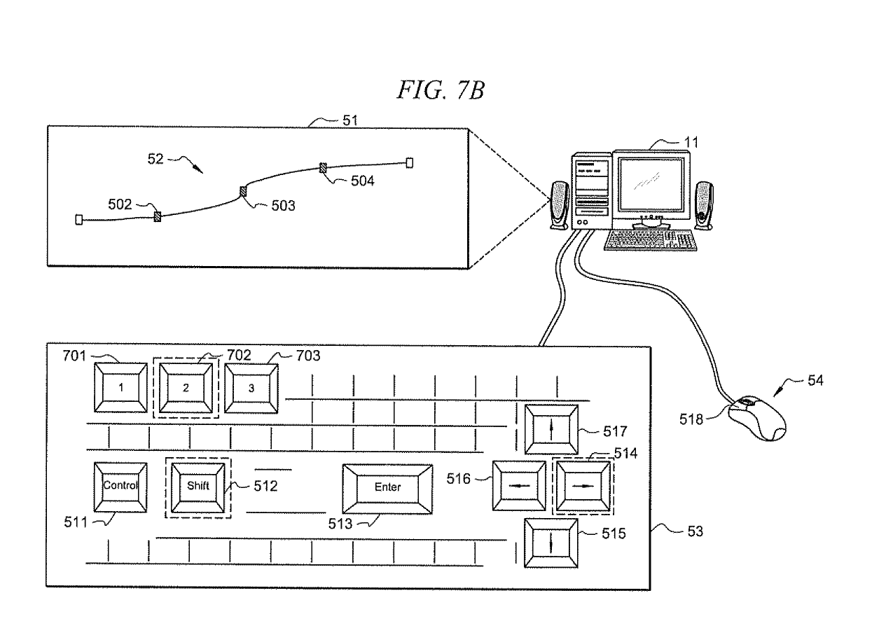

In the above examples of FIGS. 5A-5C and 6A-6C, a user can directionally advance focus along a vector path by advancing one reference point at a time. In certain embodiments, vector graphics authoring tool 51 enables a user to advance focus along a vector path by two or more reference points at a time. FIGS. 7A-7B show one exemplary embodiment in which a user can directionally advance focus along a vector path by two or more reference points at a lime. For instance, in the example of FIG. 7A, a user moves pointer 510 (via interaction with mouse 54) to be positioned over a first reference point on path 52 that is desired to be selected by the user. In the illustrated example, the user desires to select reference point 502. Thus, once pointer 510 is positioned over reference point 502, the user clicks button 518 of mouse 54 to select such reference point 502. According to this exemplary embodiment, the user holds down a hot-key on keyboard 53 while activating button 518 of mouse 54, thereby triggering a directional-advancement procedure of the authoring tool 51.

In the illustrated example of FIG. 7A, as with the example of FIG. 5A, the user holds do i shift button 512 while clicking button 518 on reference point 502. Then, as shown in FIG. 7B, the user may use directional keys 514-517 while continuing to hold down control key 511 for directionally advancing from reference point 502 along vector path 52. Further, in this example, a user may further depress one of number keys 701-703 to specify a desired number of reference points to advance. In the illustrated example, the user presses right key 514 while continuing to hold down control key 511, and further presses number key “2” 702, thus directionally advancing to the right along path 52 from reference point 502 by 2 reference points, thereby advancing to reference point 504. In this exemplary embodiment, the “shift” key 512 is used for triggering the above-mentioned directional-advancement operation in which all reference points along the range of reference points (between the originally-selected reference point 502 and the reference point 504 having current focus) are automatically selected. Thus, this exemplary advancement operation results in selection of reference points 502, 503, and 504, as shown in FIG. 7B.

If instead, the user pressed right key 514 while continuing to hold down control key 511, and further pressed number key “3” 703 in FIG. 7B, focus would have been directionally advanced to the right along path 52 from reference point 502 by 3 reference points, thereby advancing to reference point 505. Any number of advancements may be performed in this manner.

While the multiple advancement operation is described with FIGS. 7A-7B as being employed for the automatic selection directional-advancement operation (such as described above with FIGS. 5A-5C), it should be understood that the multiple advancement operation may likewise be employed for the exemplary individual-selection operation of FIGS. 6A-6C. For instance, rather than automatically selecting all reference points in the range, the “control” key 511 may be used as described above with FIGS. 6A-6C, and focus may be directionally advanced along vector path 52 by two or more reference points at a time, wherein a user may choose to individually select any reference point that gains focus.

Further, while an exemplary multiple advancement technique is described with FIGS. 7A-7B in which a user presses a number key to specify a number of reference points to advance in a given advancement operation, in certain embodiments the authoring tool 51 may be configured by the user to advance by a number of reference points (e.g., two or more) for each advancement operation. In this way, “power users” that commonly select a large number of reference points may configure the authoring tool 51 to perform such multiple advancement without requiring the user to specify the desired number for each advancement operation.

In certain embodiments, a directional advancement operation is supported by the vector graphics authoring tool 51 in which a user may advance focus from a reference point 502 on a vector path 52 that possesses current focus along the vector path 52 in m indicated direction to another reference point residing on the vector path 52, such as to reference point 503. That is, in certain embodiments, a directional advancement operation is supported that enables directional advancement of focus along a given vector path 52, whereby focus can be directionally advanced from one reference point to other reference point(s) that all reside on a common vector path 52.

In certain embodiments, another directional advancement operation is supported by the vector graphics authoring tool 51 in which a user may advance focus from a reference point on a vector path that possesses current focus in an indicated direction to another reference point that may reside on a different vector path. That is, in certain embodiments, a directional advancement operation is supported that enables directional advancement of focus from a reference point residing on a first vector path to a reference point residing on a different vector path.

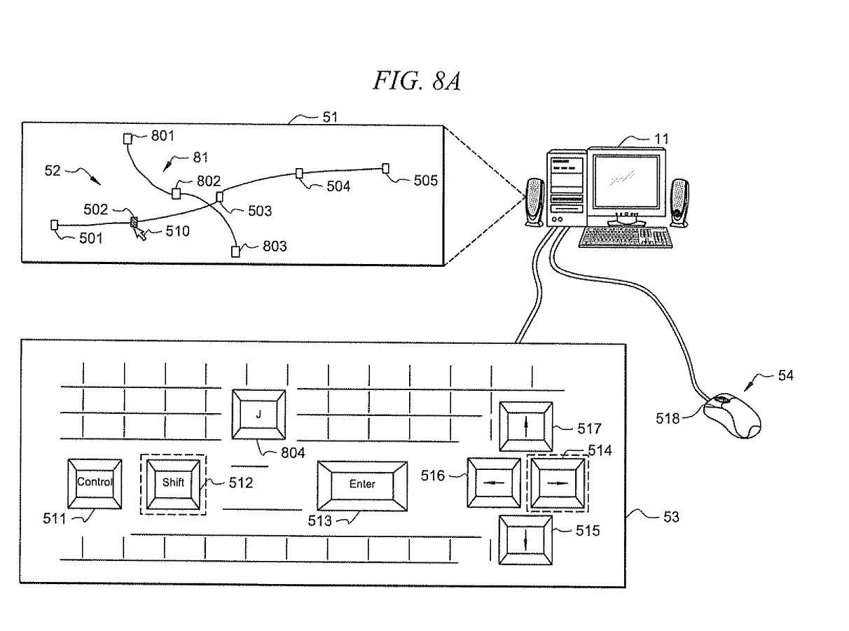

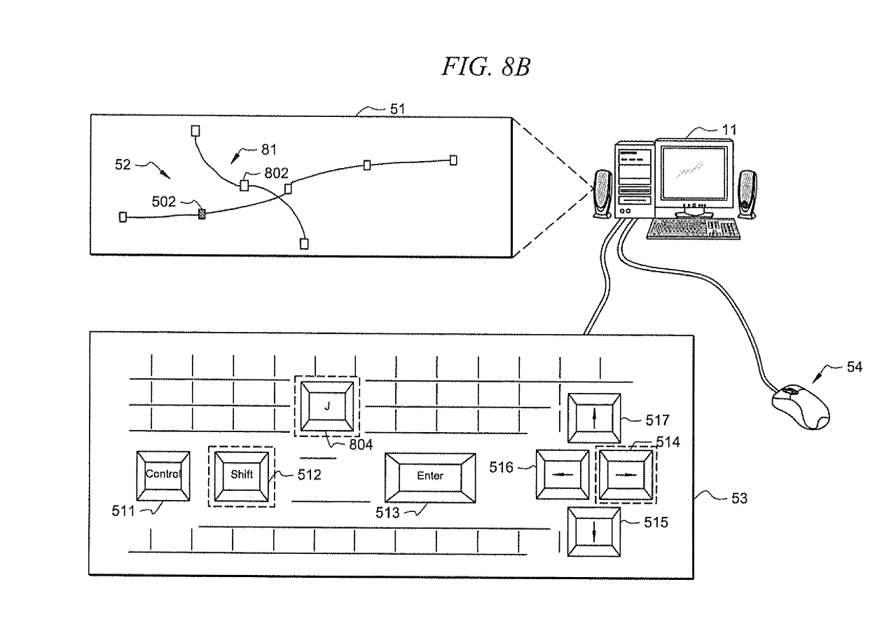

For example, turning to FIGS. 8A-8B, an exemplary directional-advancement operation for advancing from a reference point on one vector path to a reference point on another vector path is shown. In the example of FIGS. 8A-8B, an image being authored in authoring tool 51 comprises a second vector path 81, in addition to vector path 52 described in the above examples. The second vector path 81 comprises reference points 801, 802, and 803, as shown. In the example of FIG. 8A, a user moves pointer 510 (via interaction with mouse 54) to be positioned over a first reference point on first vector path 52 that is desired to be selected by the user. In the illustrated example, the user desires to select reference point 502. Thus, once pointer 510 is positioned over reference point 502, the user clicks button 518 of mouse 54 to select such reference point 502. According to this exemplary embodiment, the user holds down a hot-key on keyboard 53 while activating button 518 of mouse 54, thereby triggering a directional-advancement procedure of the authoring tool 51.

In the illustrated example of FIG. 8A, as with the example of FIG. 5A, the user holds down shift button 512 while clicking button 518 on reference point 502. Then, as shown in FIG. 5B, the user may use directional keys 514-517 while continuing to hold down control key 511 for directionally advancing from reference point 502 to another reference point. Further, in this example, a user may further depress a hot-key sequence (e.g., pressing the key “J” 804 on keyboard 53 )to trigger jumping from the reference point 502 having current focus on vector path 52 to a reference point on another vector path. For instance, responsive to the “J” key 804 being pressed for the directional advancement operation (e.g., while pressing the shift key 512 and right arrow key 514, the focus jumps in the indicated direction to a reference point 802 on vector path 81.

In other embodiments, the vector graphics authoring tool 51 may be configured to support a directional advancement operation in which advancement is made from a reference point 502 possessing current focus to a nearest adjacent reference point in the indicated direction, irrespective of whether the adjacent reference point resides on the same vector path as the reference point from which focus is advancing. In such an embodiment, the directional advancement to the right via right arrow key 514 from reference point 502 would again result in advancing focus to reference point 802 (without requiring the additional pressing of key J 804), as reference point 802 is the nearest adjacent reference point to the right of reference point 502.

While the exemplary cross-path advancement operation is described with FIGS. 8A-8B as being employed for the automatic selection directional-advancement operation (such as described above with FIGS. 5A-5C), it should be understood that the cross-path advancement operation may likewise be employed for the exemplary individual-selection operation of FIGS. 6A-6C. For instance, rather than automatically selecting all reference points in the range, the “control” key 511 may be used as described above with FIGS. 6A-6C, and focus may be directionally advanced from reference point 502 on path 52 to reference point 802 on path 81, wherein a user may choose to individually select any such reference point that gains focus.

In certain embodiments, another directional advancement operation is supported by the vector graphics authoring tool 51 in which a user may simultaneously advance focus along multiple vector paths. That is, in certain embodiments, a directional advancement operation is supported that enables a user to select reference points on multiple vector paths, and then concurrently directionally advance focus along each of the vector paths in parallel.

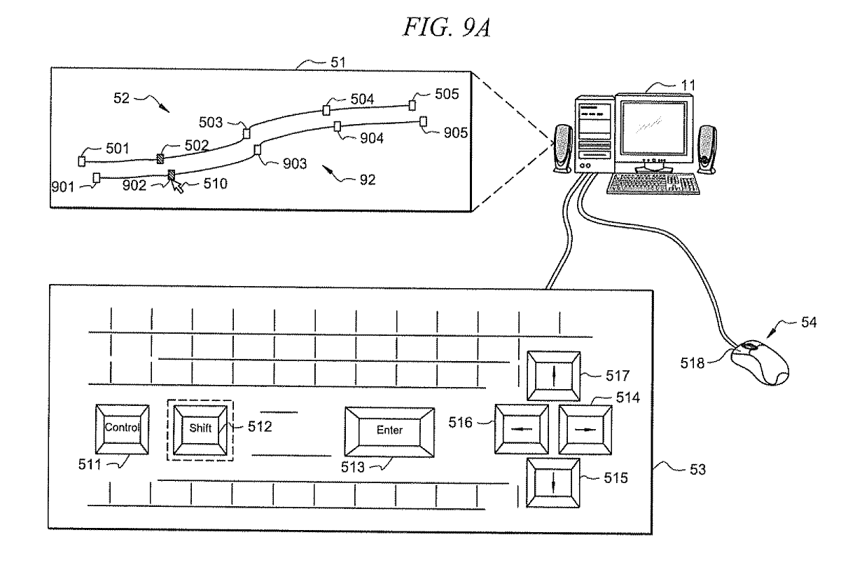

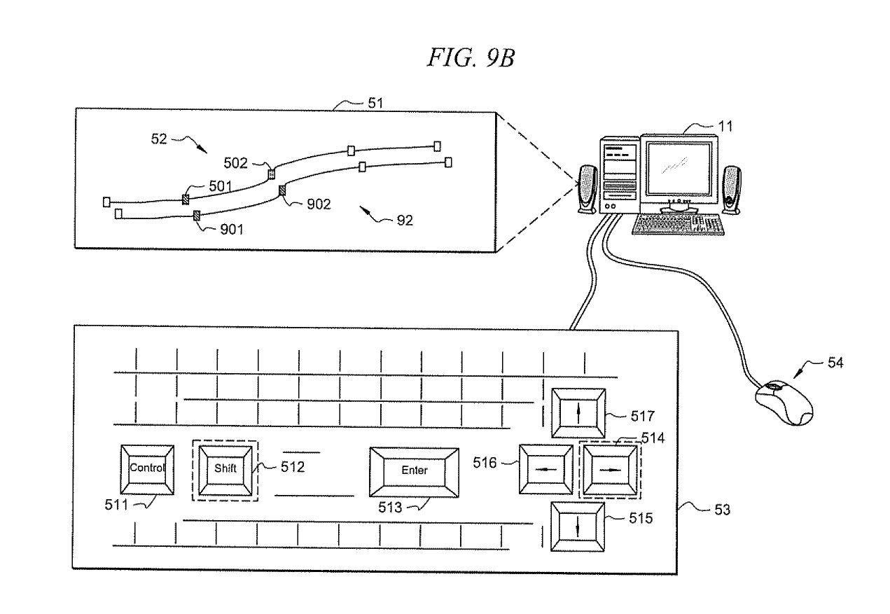

For example turning to FIGS. 9A-9B, an exemplary directional-advancement operation for simultaneously advancing focus along multiple vector paths is shown In the example of FIGS. 9A-9B, an image being authored in authoring tool 51 again comprises vector path 52 and further comprises a second vector path 92. The second vector path 92 in this example is similar to vector path 52, and comprises reference points 901, 902, 903, 904, and 905, as shown. In the example of FIG. 9A, a user may utilize a traditional point-and-click process (e.g., using mouse 54) to select reference point 502 on vector path 52 and reference point 902 on vector path 92. For instance, a user may initially click on reference point 502 while holding down shift key 512, and then move pointer 510 (via interaction with mouse 54) to be positioned over reference point 902 on vector path 92 and also click on that reference point 902 to select both reference points 502 and 902.

Then, as shown in FIG. 9B, the user may use directional keys 514-517 while continuing to hold down control key 511 for directionally advancing along each of paths 52 and 92 simultaneously. For instance, in the illustrated example of FIG. 9B, right arrow key 514 causes advancement of focus to the right along each of paths 52 and 902, thereby advancing focus from reference points 501 and 901 to reference points 502 and 902. While the exemplary multiple-path advancement operation is described with FIGS. 9A-9B as being employed for the automatic selection directional-advancement operation (such as described above with FIGS. 5A-5C), it should be understood that the multiple-path advancement operation may likewise be employed for the exemplary individual-selection operation of FIGS. 6A-6C. For instance, rather than automatically selecting all reference points in the range along each of paths 501 and 901, the “control” key 511 may be used as described above with FIGS. 6A-6C, and focus may be directionally advanced along the two paths simultaneously, wherein a user may choose to individually select any such reference points along the paths 52 and 92 that gain focus.

In certain embodiments, vector graphics authoring tool 51 maintains properties associated with each vector shape (or “object”) that is included in an image. Such properties are maintained as computer-readable data stored to some computer-readable medium, which may be in the form of any suitable data structure, such as a file, table, database, etc. Such properties may include information relating to the shape object as positional coordinates (e.g., X,Y coordinates) for elements of the shape object, such as its reference points. The properties may also include information identifying a relational order of the reference points (or this information may be derived from the positional coordinates). The properties may also include information for each reference point identifying whether the reference point is currently selected. Various other properties information may be included for the shape object, including information identifying mathematics defining the shape (or elements, such as segments, of the shape), etc. Table 1 below shows one exemplary representation of properties data that may be maintained for a shape object.

TABLE 1
Shape Object Properties.

| Ordered Reference Points | Position | Selection Flag |
|---|---|---|
| 1 | X₁, Y₁ | False |
| 2 | X₂, Y₂ | False |
| 3 | X₃, Y₃ | False |
| . . . | . . . | . . . |

In the example of Table 1, none of the reference points of the shape object are selected, and thus all of the selection flags are set to “False”. Responsive to a reference point being selected (e.g., using a selection technique as described herein), the reference point's corresponding selection flag may be changed to “True” while it is selected. For example responsive to a user selecting reference point 2 of the object represented in Table 1, its corresponding selection flag is set to “True”, as shown in Table 2 below.

TABLE 2
Shape Object Properties Following A Selection of Reference Point

| Ordered Reference Points | Position | Selection Flag |
|---|---|---|
| 1 | X₁, Y₁ | False |
| 2 | X₂, Y₂ | True |
| 3 | X₃, Y₃ | False |
| . . . | . . . | . . . |

Thus, the vector graphics authoring tool 51 can keep track of which reference points are selected. Additionally, the ordering and/or coordinate information may be used by the authoring tool 51 for determining a next reference point to which focus should be advanced responsive to a received directional input request. Further, in certain embodiments, the directional advancement operation may wrap-around a vector path. For instance, when advancement in a given direction reaches the end of the path, the next advancement in that direction may wrap to advance focus to the first reference point in the path. For example, returning attention briefly to vector path 52 shown in FIGS. 5A-5B, suppose a user originally selects reference point 502 and then performs directional advancement along path 52 to the right to select reference point 503, then reference point 504, and then reference point 505; the next directional advancement to the right from the last reference point 505 will, in certain embodiments, wrap around to advance focus to the first reference point 501 of vector path 52.

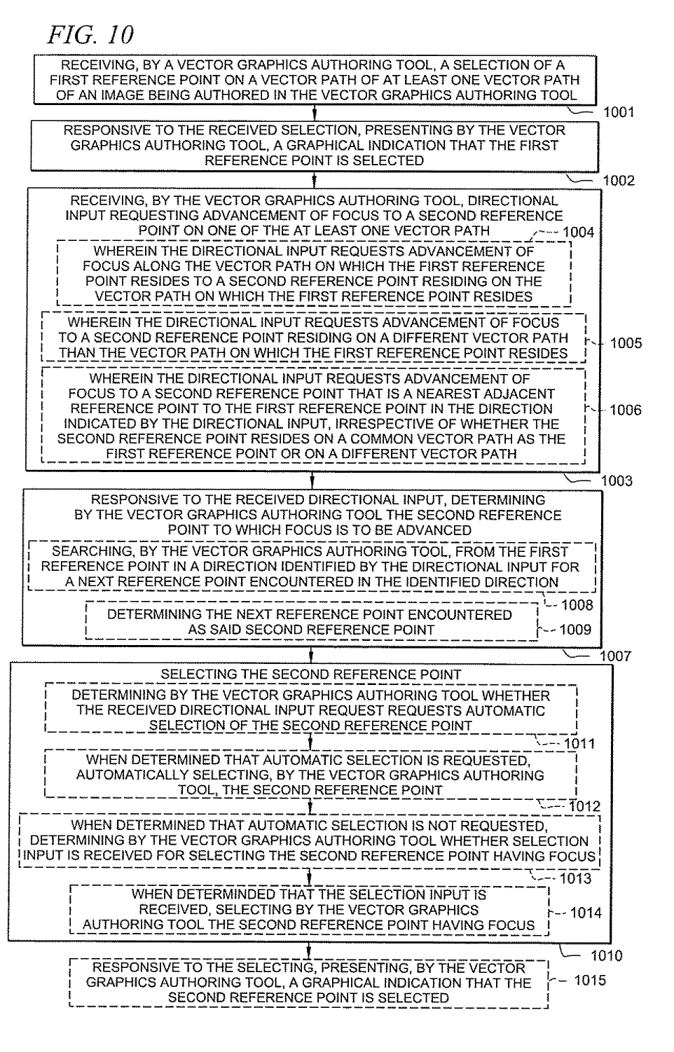

Turning to FIG. 10, an exemplary operational flow diagram according to one embodiment of the present invention is shown. In operational block 1001, vector graphics authoring tool 51 receives a selection of a first reference point on a vector path of at least one vector path of an image being authored. For instance, such selection may be received by traditional point-and-click input from a user. In certain embodiments, the vector graphics authoring tool 51 presents a graphical indication that the first reference point is selected in operational block 1002 (which is shown in dashed lines as being optional in this embodiment). For instance, as shown in the above examples of FIGS. 4A-9B, a selected reference point may be indicated as being selected by being filled (e.g., a square reference point filled with some color), whereas unselected reference points may be indicated as not selected by being unfilled.

In operational block 1003, the vector graphics authoring tool receives directional input requesting advancement of focus to a second reference point on one of the at least one vector paths. For instance, as described above, a directional advancement operation may be triggered and input indicating a direction for advancement may be received (e.g., which may be input via arrow keys on a keyboard, directional movement of a mouse, etc.). As described further herein, such directional input received in block 1003 does not comprise a user directly identifying the second reference point (e.g., clicking directly on the second reference point).

Various optional characteristics of such receiving operation 1003 of this exemplary embodiment are shown in dashed-line blocks 1004-1006. For instance, in certain embodiments, the directional input requests advancement of focus along the vector path on which the first reference point resides to a second reference point residing on the vector path on which the first reference point resides, as in block 1004. That is, in certain embodiments, the directional advancement is performed along the vector path on which the first vector point resides for discovering the second vector point on the same vector path.

As shown in block 1005, in certain embodiments the directional input requests advancement of focus to second reference point residing on a different vector path than the vector path on which the first reference point resides, such as in the exemplar operation discussed above with FIGS. 8A-8B. Further, in certain embodiments, such as shown in block 1006, the directional input requests advancement of focus to a second reference point that is a nearest adjacent reference point to the first reference point in the direction indicated by the directional input, irrespective of whether the second reference point resides on a common vector path as the first reference point or resides on a different vector path.

In operational block 1007, the vector graphics authoring tool determines the second reference point to which focus is to be advanced responsive to the received directional input. In one embodiment, such determining operation 1007 comprises performance of optional blocks 1008-1009. In block 1008, the vector graphics authoring tool 51 searches from the first reference point in a direction identified by the directional input for a next reference point encountered in the identified direction. As mentioned above, the search may be performed along a path on which the first reference point resides for a next reference point residing on such path, or the search may be performed across paths. In block 1009, the vector graphics authoring tool 51 determines the next reference point that is encountered in the search as the second reference point to which focus is to be advanced.

In operational block 1010, the second reference point is selected. As discussed above, such selection may be performed automatically by the vector graphics authoring tool 51 in certain embodiments, or it may be performed responsive to user input. Thus, according to one embodiment, vector graphics authoring tool 51 performs the optional operations 1011-1014 in performing the selecting operation of block 1010. In block 1011, the vector graphics authoring tool 51 determines whether the received directional input request requests automatic selection of the second reference point. When determined that automatic selection is requested, the vector graphics authoring tool 51 automatically selects (in block 1012) the second reference point. When determined that automatic selection is not requested, the vector graphics authoring tool 51 determines (in block 1013) whether selection input (e.g., pressing of enter key 513 in FIG. 6C discussed above) is received for selecting the second reference point having focus. When determined that the selection input is received, the vector graphics authoring tool selects (in block 1014) the second reference point having focus.

In certain embodiments, the vector graphics authoring tool 51 presents a graphical indication that the second reference point is selected in operational block 1015 (which is shown in dashed lines as being optional in this embodiment). For instance, such selected reference point may be indicated as being selected by being filled.

When implemented via computer-executable instructions, various elements of embodiments of the present invention are in essence the software code defining the operations of such various elements. The executable instructions or software code may be obtained from a readable medium (erg., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

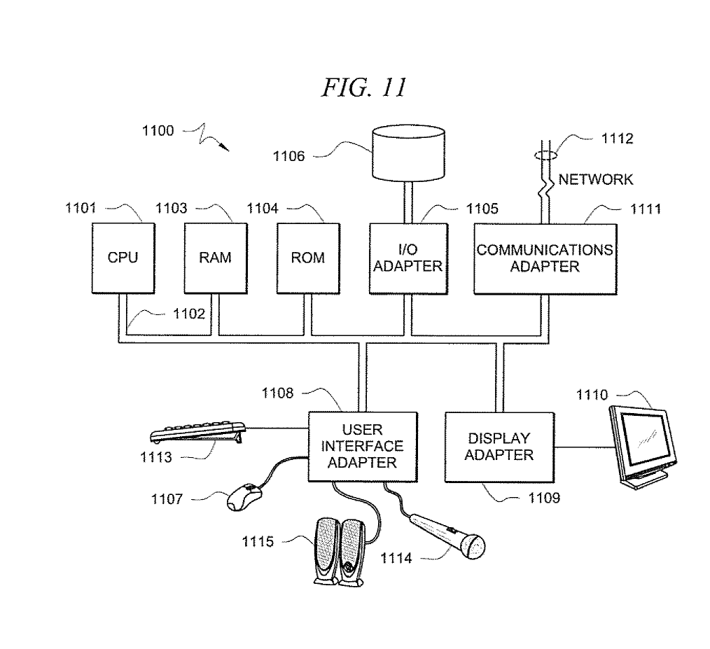

FIG. 11 illustrates an exemplary computer system 1100 on which vector graphics authoring tool 51 may be implemented according to one embodiment of the present invention. Central processing unit (CPU) 1101 is coupled to system bus 1102. CPU 1101 may be any general-purpose CPU. The present invention is not restricted by the architecture of CPU 1101 (or other components of exemplary system 1100) as long as CPU 1101 (and other components of system 1100) supports the inventive operations as described herein. CPU 1101 may execute the various logical instructions according to embodiments of the present invention. For example, CPU 1101 may execute machine-level instructions according to the exemplary operational flow described above in conjunction with FIG. 10.

Computer system 1100 also preferably includes random access memory (RAM) 1103, which may be SRAM, SDRAM, or the like. Computer system 1100 preferably includes read-only memory (ROM) 1104 which may be PROM, EPROM, EEPROM, or the like. RAM 1103 and ROM 1104 hold user and system data and programs, as is well known in the art.

Computer system 1100 also preferably includes input/output (I/O) adapter 1105, communications adapter 1111, user interface adapter 1108, and display adapter 1109. I/O adapter 1105, user interface adapter 1108, and/or communications adapter 1111 may, in certain embodiments, enable a user to interact with computer system 1100 in order to input information, such as interacting with a user interface to request directional advancement from one reference point on a vector path to another reference point, as described above.

I/O adapter 1105 preferably connects to storage device(s) 1106, such as one or more of hard drive, compact disc (CD) drive, floppy disk drive, tape drive, etc. to computer system 1100. The storage devices may be utilized when RAM 1103 is insufficient for the memory requirements associated with storing data for operations of the authoring tool 51. Communications adapter 1111 is preferably adapted to couple computer system 1100 to network 1112 which may enable information to be input to and/or output from system 1100 via such network 1112 (e.g., the Internet or other wide-area network, a local-area network, a public or private switched telephony network, a wireless network, any combination of the foregoing). User interface adapter 1108 couples user input devices, such as keyboard 1113, pointing device 1107, and microphone 1114 and/or output devices, such as speaker(s) 1115 to computer system 1100. Display adapter 1109 is driven by CPU 1101 to control the display on display device 1110 to, for example, display information pertaining to a vector graphical image being authored, according to certain embodiments of the present invention.

It shall be appreciated that the present invention is not limited to the architecture of system 1100. For example, any suitable processor-based device may be utilized for implementing authoring tool 51, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer-implemented method comprising:
displaying an image in an application executed by a processor, the image comprising at least one vector path and a first reference point and a second reference point, the at least one vector path comprising the first reference point, the first reference point configured to be used to modify a shape of the vector path;
setting a focus on the first reference point and updating the image by the application to indicate the setting of focus on the first reference point
receiving a selection input, the selection input configured to cause the application to select a reference point having focus;
in response to receiving the selection input, selecting the first reference point and
updating the image by the application to indicate the selection of the first reference point;
receiving a directional input by the application, the directional input configured to request advancement of the focus from the first reference point to another reference point;
determining the second reference point to which the focus is to be advanced by the application based on the directional input;
advancing the focus to the second reference point by the application;
updating the image by the application to indicate the focus on the second reference point;
receiving the selection input; and
in response to receiving the selection input, selecting the second reference point and updating the image by the application to indicate the selection of the second reference point.

2. (canceled)

3. The method of claim 1 wherein said directional input does not comprise a user directly identifying the second reference point to which the focus is to be advanced.

4. The method of claim 1 wherein said directional input comprises at least one of:
input of an arrow key on a keyboard that specifies a direction of said advancement of the focus, movement of a pointing device in a direction of said advancement of the focus, or movement of a finger on a touchpad in the direction of said advancement of the focus.

5. The method of claim 1 wherein said determining comprises:
determining, by the application, the second reference point on said vector path on which said first reference point resides.

6. The method of claim 5 wherein said determining the second reference point further comprises:
determining, by the application as the second reference point, a next reference point encountered on said vector path on which said first reference point resides when traversing the vector path from the first reference point in a direction indicated by the directional input.

7. The method of claim 1 wherein said determining the second reference point further comprises:
determining, by the application as the second reference point, a next reference point encountered on any of said at least one vector path when searching from the first reference point in a direction indicated by the directional input.

8. The method of claim 1 wherein said determining comprises:
determining, by the application, the second reference point on a different vector path than said vector path on which said first reference point resides.

9. The method of claim 8 further comprising:
receiving, by the application, input requesting to determine said second reference point on said different vector path than said vector path on which said first reference point resides.

10. The method of claim 1 wherein:
advancing the focus automatically generates the selection input by said vector graphics authoring tool.

11. (canceled)

12. (canceled)

13. (canceled)

14. (canceled)

15. (canceled)

16. (canceled)

17. (canceled)

18. (canceled)

19. Computer-executable software code stored to a non-transitory computer-readable medium, which when executed by a computer causes the computer to perform a method comprising:
displaying an image comprising at least one vector path and a first reference point and a second reference point, the at least one vector path comprising the first reference point, the first reference point configured to be used to modify a shape of the vector path;
setting a focus on the first reference point and updating the image to indicate the setting of focus on the first reference point
receiving a selection input, the selection input configured to cause a selection of a reference point having focus;
in response to receiving the selection input, selecting the first reference point and
updating the image to indicate the selection of the first reference point;
receiving a directional input, the directional input configured to request advancement of the focus from the first reference point to another reference point;
determining the second reference point to which the focus is to be advanced based on the directional input;
advancing the focus to the second reference point;
updating the image to indicate the focus on the second reference point;
receiving the selection input; and
in response to receiving the selection input, selecting the second reference point and updating the image to indicate the selection of the second reference point.

20. The computer-executable software code of claim 19 wherein said determining comprises:
searching along the vector path in a direction indicated by the directional input.

21. The computer-executable software code of claim 20 wherein said determining comprises:
determining an adjacent reference point on the vector path that is encountered in said searching along the vector path.

22. The computer-executable software code of claim 19 wherein when executed by the computer the software code causes the computer to further perform:
automatically generating the selection input in response to advancing the focus to the second reference point.

23. A system comprising:
computer-readable medium to which instructions are stored;
processor operable to execute said instructions that when executed by the processor causes the processor to:
display an image in an application, the image comprising at least one vector path and a first reference point and a second reference point, the at least one vector path comprising the first reference point, the first reference point configured to be used to modify a shape of the vector path;
set a focus on the first reference point and update the image to indicate the setting of focus on the first reference point
receive a selection input, the selection input configured to cause a selection of a reference point having focus;
in response to receiving the selection input, select the first reference point and
update the image to indicate the selection of the first reference point;
receive a directional input, the directional input configured to request advancement of the focus from the first reference point to another reference point;
determine the second reference point to which the focus is to be advanced based on the directional input;
advance the focus to the second reference point;
update the image to indicate the focus on the second reference point;
receive the selection input; and
in response to receiving the selection input, select the second reference point and update the image to indicate the selection of the second reference point.

24. The system of claim 23 wherein the directional input does not comprise direct identification of the second reference point.

25. The system of claim 23 wherein said instructions that when executed by the processor further causes the processor to automatically select the second reference point to which said focus is advanced.

26. The computer-executable software code of claim 19 wherein advancing focus to the second reference point is configured to automatically generate the selection input.

27. The computer-executable software code of claim 19 wherein when executed by the computer the software code causes the computer to further perform
determining the second reference point on said vector path on which said first reference point resides.

28. The computer-executable software code of claim 19 wherein said determining the second reference point further comprises:
determining a next reference point encountered on any of said at least one vector path when searching from the first reference point in a direction indicated by the directional input.

29. The computer-executable software code of claim 19 wherein said determining comprises:
determining the second reference point on a different vector path than said vector path on which said first reference point resides.

30. The system of claim 23 wherein advancing the focus automatically generates the selection input.

31. The system of claim 23 further comprising instructions that when executed by the processor causes the processor to:
determine the second reference point on said vector path on which said first reference point resides.

32. The system of claim 23 further comprising instructions that when executed by the processor causes the processor to:
determining a next reference point encountered on any of said at least one vector path when searching from the first reference point in a direction indicated by the directional input.

33. The system of claim 23 further comprising instructions that when executed by the processor causes the processor to:
determine the second reference point on a different vector path than said vector path on which said first reference point resides.

34. A non-transitory computer-readable medium comprising program code, the program code comprising:
program code for displaying an image comprising at least one path and a plurality of reference points, a first reference point of the plurality of reference points configured to be used to modify a shape of the path;
program code for setting a focus on the first reference point;
program code for receiving a selection input, the selection input configured to cause the application to select a reference point having focus;
program code for, in response to receiving the selection input, selecting the first reference point;
program code for receiving a directional input from an input device, the directional input configured to advance the focus from the first reference point to another of the plurality of references points;
program code for, in response to receiving the directional input, determining a second reference point of the plurality of reference points based at least in part on the directional input;
program code for setting the focus to the second reference point; and
program code for, in response to subsequently receiving the selection input, selecting the second reference point.

35. The non-transitory computer-readable medium of claim 34 wherein the program code for setting the focus to the the second reference point comprises program code for automatically generating the selection input substantially simultaneously with setting the focus to the second reference point.
